(19) United States
(12) Patent Application Publication
(10) Pub. No.: US 2008/0276613 A1
(43) Pub. Date: Nov. 13, 2008

(54) DISCRETE VARIABLE GEOMETRY COMPRESSOR

(76) Inventors: Phillipe Noelle, Vincey (FR); Nicolas Vazeille, Nancy (FR); Nicolas Massard, Nancy (FR)

Correspondence Address: HONEYWELL TURBO TECHNOLOGIES, 23326 HAWTHORNE BOULEVARD, SUITE #200, TORRANCE, CA, 90505, US

(21) Appl. No.: 11/746,203

(22) Filed: May 9, 2007

(51) Int. Cl. F02B 71/04

(52) U.S. Cl. 60/595; 60/598; 92/95

(57) ABSTRACT

A variable geometry compressor having a housing, a compressor wheel and a plurality of vanes positioned between an exducer of the compressor wheel and a housing volute. The vanes are adjustable through a range of positions, but a vane actuation system is configured to actuate the vanes through three discrete positions from among the range of positions. The actuation system has an actuator that includes an actuator housing containing a diaphragm that divides a housing chamber into two portions. Through the application of a vacuum to either chamber portion, the diaphragm drives a rod to actuate the vanes between two of the discrete vane positions, while a spring returns the vanes to the third position when no vacuum is applied. The actuator is controlled by an open-loop controller.

This invention relates generally to the field of variable geometry turbochargers. More particularly, the present invention provides apparatus and methods for actuating multiple aerodynamic vanes in a diffuser of a compressor housing.

### BACKGROUND OF THE INVENTION

In turbocharger technology a rotating compressor wheel within a compressor housing sucks air through an intake duct, compresses it in an impeller passage, and diffuses it through a diffuser into a volute. From the volute, the compressed air is supplied to an intake manifold of an internal combustion engine.

The operating range of a compressor extends from a surge condition (wherein the airflow is “surging”), occurring at low airflow rates, to a choke condition (wherein the airflow is “choked”) experienced at high airflow rates. Surging airflow occurs when a compressor operates at a relatively low flow rate with respect to the compressor pressure ratio, and the resulting flow of air throughout the compressor becomes unstable. Choking occurs when a compressor tries to operate at a high flow rate that exceeds the mass flow rate available through the limited area of an intake end of the compressor wheel (known as the inducer) through which air arrives at the compressor wheel.

To improve the operating range and/or efficiency of a turbocharger compressor, it may be desirable to control the flow of compressed air through the diffuser, and thus variable geometry compressors (VGCs) have been developed.

Such VGCs typically use adjustable vanes to control compressed airflow from the impeller passage to the volute. For example, multiple pivoting vanes may be annularly positioned around a compressor wheel exducer and commonly controlled by a unison ring to alter the throat area of passages between the vanes. The turbocharger thereby adjusts the airflow from the exducer (i.e., the amount of compressed air coming from the compressor wheel), and thus adjusts the related compressor map. This control may result in more engine power, more engine torque and/or more engine speed.

While the development of multiple vane variable diffuser compressors may improve compressor flow range and efficiency, the complexity and related limitations of support and actuation structures for the vanes may cause significant manufacturing costs and occasionally create maintenance and reliability issues (e.g., the vanes may become stuck). It is therefore desirable to reduce the complexity and parts count of VGCs and improve the actuation systems to increase reliability and reduce manufacturing and maintenance costs for turbochargers employing them.

A variety of control schemes exist for controlling geometry in variable geometry turbines, and similar ones may be used for controlling VGCs. However, such schemes may exhibit time lags, hysteresis, and other characteristics that can compromise or limit geometry control. Thus, a need exists for new control schemes that can overcome such limitations. Methods, devices, systems, etc., for controlling geometry in VGCs are described below.

Accordingly, there has existed a need for an apparatus and related methods to reduce the complexity, maintenance costs and manufacturing costs, and increase the reliability of VGC turbochargers, while improving their operational characteristics. Moreover, it is preferable that such apparatus are simple and weight efficient. Preferred embodiments of the present invention satisfy these and other needs, and provide further related advantages.

### SUMMARY OF THE INVENTION

In various embodiments, the present invention solves some or all of the needs mentioned above, typically providing a reliable turbocharged engine, turbocharger system, and/or turbocharger compressor at low cost and with a simple, lightweight design.

The compressor is a variable geometry compressor having a housing, a wheel, and a variable geometry member (e.g., a plurality of vanes driven by a unison ring). The housing defines an inlet leading to an impeller passageway and a volute leading from the impeller passageway. The wheel is carried within the compressor housing, and is driven in rotation within the impeller passageway, thereby compressing air received from the inlet. The compressed air is driven into the volute by the compressor wheel and via the variable geometry member, which is intermediate the compressor wheel and the volute. The variable geometry member is configured to move through a range of positions that affect the flow of compressed air from the compressor wheel to the volute.

An actuation is configured to actuate the variable geometry member exclusively between a plurality of discrete positions from among its range of positions, and can be run using an open-loop control system. Advantageously, because the actuation system only uses discrete positions (e.g., three positions), the system can be efficiently run without the reliability, maintenance, weight and cost issues that might be incurred with position sensors and the additional complexity of a closed-loop control system. Moreover, the system can be simply made to operate with a strong force capacity to resist vane-sticking problems and decrease response time.

Other features and advantages of the invention will become apparent from the following detailed description of the preferred embodiments, taken with the accompanying drawings, which illustrate, by way of example, the principles of the invention. The detailed description of particular preferred embodiments, as set out below to enable one to build and use an embodiment of the invention, are not intended to limit the enumerated claims, but rather, they are intended to serve as particular examples of the claimed invention.

### BRIEF DESCRIPTION OF THE DRAWINGS

FIG. 1 is a system layout of an internal combustion engine with a turbocharger and a charge air cooler embodying the present invention.

FIG. 2 is a right side cross-section view of a compressor depicted as part of the turbocharger in FIG. 2.

FIG. 3 is a system layout of an actuation system, including a front cross-section view of a 3-position vacuum actuator, as is used on the compressor of FIG. 2.

FIG. 4 is an operating protocol for a control system used to control the 3-position vacuum actuator of FIG. 2.

FIG. 5 is a compressor map for the compressor of FIG. 2.

### DETAILED DESCRIPTION OF THE PREFERRED EMBODIMENTS

The invention summarized above and defined by the enumerated claims may be better understood by referring to the following detailed description, which should be read with the accompanying drawings. This detailed description of particular preferred embodiments of the invention, set out below to enable one to build and use particular implementations of the invention, is not intended to limit the enumerated claims, but rather, it is intended to provide particular examples of them.

Typical embodiments of the present invention reside in a vane control system for a turbocharger, along with associated methods and apparatus (e.g., compressors, turbochargers and turbocharged internal combustion engines). Preferred embodiments of the invention are assemblies that provide for improved pressure ratios and/or related flow characteristics through the use of an actuation system configured to actuate a plurality of vanes exclusively through a plurality of discrete positions from among a range of positions.

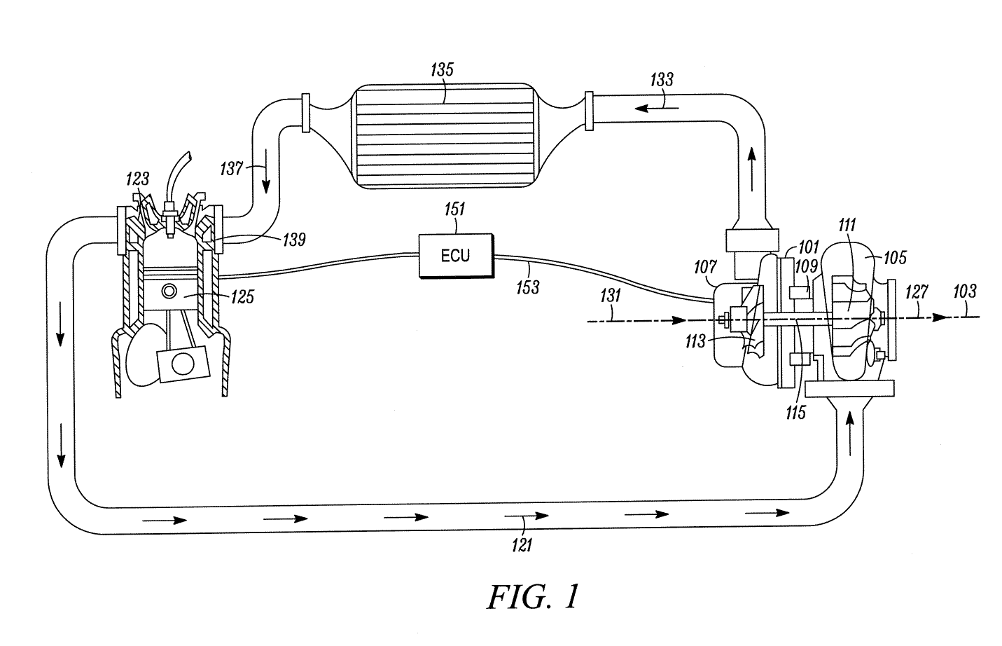

With reference to FIG. 1, in a first embodiment of the invention, a turbocharger 101 includes a turbocharger housing and a rotor configured to rotate within the turbocharger housing along an axis of rotor rotation 103 on thrust bearings and journal bearings (or alternatively, other bearings such as ball bearings). The turbocharger housing includes a turbine housing 105, a compressor housing 107, and a bearing housing 109 (i.e., center housing) that connects the turbine housing to the compressor housing. The rotor includes a turbine wheel 111 located substantially within the turbine housing, a compressor wheel 113 located substantially within the compressor housing, and a shaft 115 extending along the axis of rotor rotation, through the bearing housing, to connect the turbine wheel to the compressor wheel.

The turbine housing 105 and turbine wheel 111 form a turbine configured to circumferentially receive a high-pressure and high-temperature exhaust gas stream 121 from an engine, e.g., from an exhaust manifold 123 of an internal combustion engine 125. The turbine wheel (and thus the rotor) is driven in rotation around the axis of rotor rotation 103 by the high-pressure and high-temperature exhaust gas stream, which becomes a lower-pressure and lower-temperature exhaust gas stream 127 and is axially released into an exhaust system (not shown).

The compressor housing 107 and compressor wheel 113 form a compressor stage. The compressor wheel, being driven in rotation by the exhaust-gas driven turbine wheel 111, is configured to compress axially received input air (e.g., ambient air 131, or already-pressurized air from a previous-stage in a multi-stage compressor) into a pressurized air stream 133 that is ejected circumferentially from the compressor. Due to the compression process, the pressurized air stream is characterized by an increased temperature, over that of the input air. Optionally, the pressurized air stream may be channeled through a convectively cooled charge air cooler 135 configured to dissipate heat from the pressurized air stream, increasing its density. The resulting cooled and pressurized output air stream 137 is channeled into an intake manifold 139 on the internal combustion engine, or alternatively, into a subsequent-stage, in-series compressor. The operation of the system is controlled by an ECU 151 (electronic control unit) that connects to the remainder of the system via communication connections 153.

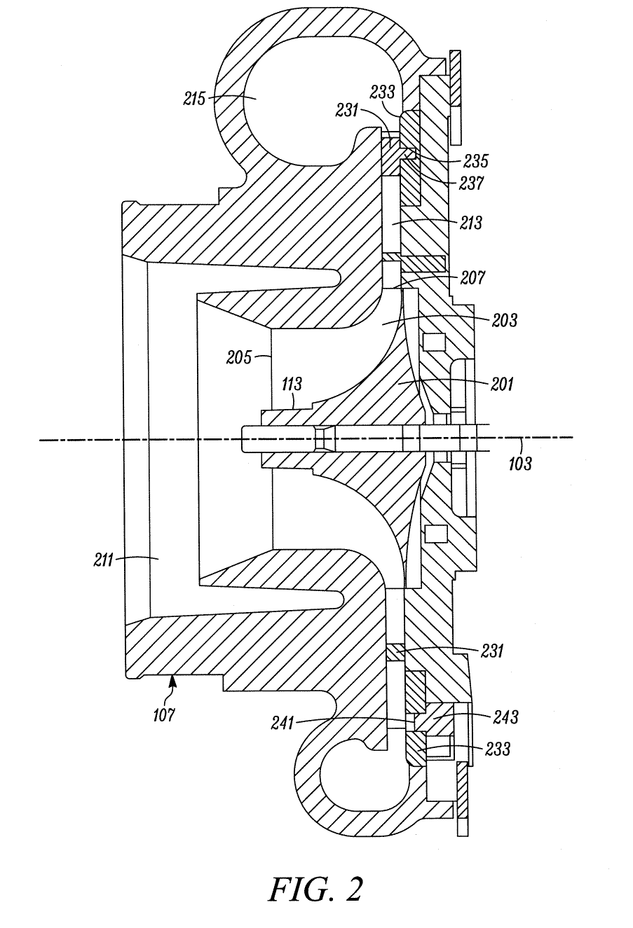

With reference to FIGS. 1 and 2, the compressor wheel 113 is a radial compressor wheel that includes a hub 201 and a plurality of blades 203. The blades preferably have a backward curvature (i.e., a back swept angle wherein the wheel exit blade angle is backward swept circumferentially relative to a radial line and the leading edges of the blades lead the trailing edges of the blades when the hub is rotated to compress air) rather than being configured to extend in a purely radial blade configuration. Because the blades have backward curvature, a typical view of an impeller might not accurately depict the radius of the blade at several different radial locations on the blade. Such radii may be more accurately depicted using a meridional view—a rotational projection of a blade onto a plane containing the hub axis of rotation (e.g., a rotational projection of a side view of a blade on to the plane of the view). FIG. 2 depicts the blades in such a projection.

Each blade 203 has a leading edge 205 that defines the beginning of an inducer (i.e., an intake area for the combined set of blades, extending through the circular paths of roughly the upstream ⅓ of the blades), and a trailing edge 207 that defines the end of an exducer (i.e., a typically annular output area for the combined set of blades, extending through the circular paths of roughly the downstream ⅓ of the blades). Alternative embodiments may include compressor wheels with splitter blades.

The compressor housing 107 and compressor wheel 113 form a compression-air passageway, serially including an intake duct 211 leading axially into the inducer, an impeller passage leading from the inducer through the exducer and substantially conforming to the space through which the blades rotate, a diffuser 213 leading radially outward from the exducer, and a volute 215 extending around the diffuser. The volute forms a scroll shape, and forms an outlet for the compressor through which the pressurized air stream is ejected circumferentially (i.e., normal to the radius of the scroll at the exit) as the pressurized air stream 133 that passes to the (optional) charge air cooler and intake manifold.

As is typical in automotive applications for a single stage turbo charging system, the intake duct is fed a stream of filtered external air from an intake passage in fluid communication with the external atmosphere. Each portion of the compression-air passageway is serially in fluid communication with the next. Alternative embodiments may include other types of turbo charging systems, such as two-stage turbochargers configured such that the air compressed by a first stage is used as the intake air of a second stage.

The compressor housing 107 also encloses a plurality of pivoting vanes 231 interposed in the diffuser 213 intermediate the downstream end of the compressor wheel exducer (i.e., the compressor blade trailing edges 207) and the volute 215.

A compressor adjustment or unison ring 233 is rotatably disposed within the compressor housing 107 and is configured to engage and rotatably move all of the compressor vanes 231 in unison. The compressor unison ring 233 defines a plurality of slots 235 disposed therein, and that are each configured to provide a minimum backlash and a large area contact when combined with correspondingly shaped tabs 237 projecting from each respective compressor vane. The compressor unison ring 233 preferably effects rotation of the plurality of compressor vanes 231 through identical angular movement. The diffuser, unison ring and vanes are part of a variable geometry member for the compressor.

The unison ring 233 also defines a slot in which an actuation pin 241 is received. An actuation member (i.e., a rod 243) is attached at one of its ends to the actuation pin 241, and longitudinally extends normal to the plane of FIG. 2. Longitudinal translation of the actuation rod 243 translates compressor unison ring actuation pin 241, which drives the compressor unison ring 233 to rotate around the axis of rotation 103, which in turn causes each of the compressor vanes 231 to move (i.e., be pivoted) radially inwardly or outwardly relative to the compressor wheel 113.

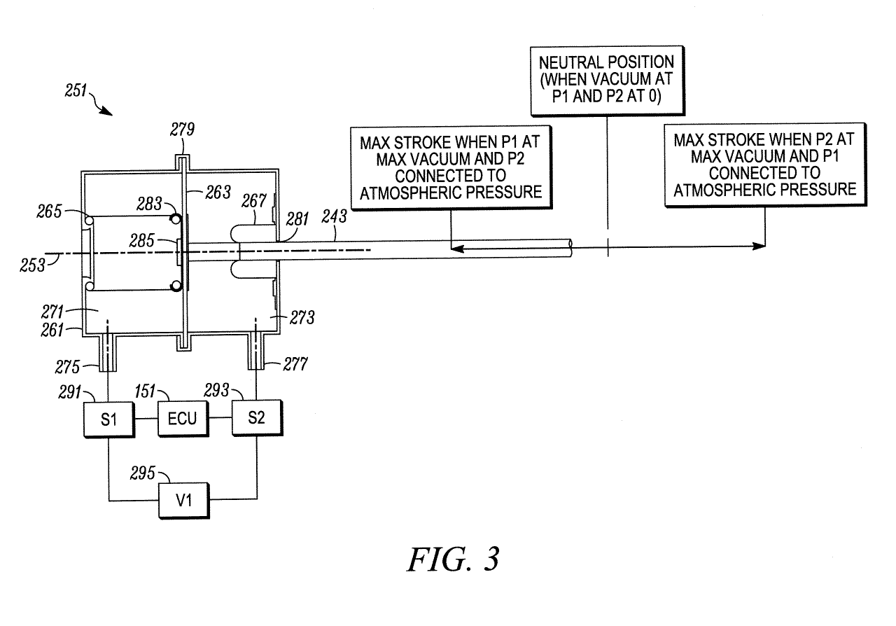

With reference to FIGS. 1 to 3, the actuation rod 243 is part of a 3-position vacuum actuator 251. The rod extends along an axis of actuation 253 from the actuation pin 241 to the remainder of the 3-position vacuum actuator. The actuator is configured to actuate the variable geometry member (i.e., the vanes) via the rod, through three discrete positions from among the range of positions through which it moves.

In addition to the rod, the actuator further includes an actuator housing 261 that is rigidly attached to (and reacts against) the compressor housing 107, a diaphragm 263, a spring 265, and a seal 267. The actuator housing defines an enclosed chamber, and the diaphragm is positioned within the chamber, dividing it into a first chamber portion 271 and a second chamber portion 273. A first port 275 (P1) pneumatically opens into the first chamber portion 271 and a second port 277 (P2) pneumatically opens into the second chamber portion 273. The diaphragm is retained intermediate the two chamber portions by a seam 279 in the actuator housing, extending around the chamber and pneumatically isolating the two chamber portions with the diaphragm.

The rod 243 extends through an opening 281 in the actuator housing 261, and attaches to the diaphragm 263 within the chamber using a flat piston 283 and a washer 285. The seal 267 is a boot seal that connects to the actuator housing 261 and the rod 243, and thereby pneumatically seals the opening 281 with respect to the chamber. The spring 265 extends between the piston 283 and a wall of the actuator housing 261, and is configured to extend and contract with the deflecting diaphragm when the rod longitudinally moves relative to the actuator housing.

The rod 243 is configured to actuate between three discrete positions that depend upon deflection of the diaphragm 263 within the chamber. The first position is established by the full deflection of the diaphragm when a relative low-pressure condition is established in the first chamber portion by the application of a vacuum via the first port 275. The second position is established by the full deflection of the diaphragm when a relative low-pressure condition is established in the second chamber portion by the application of a vacuum via the second port 277. For this embodiment, it should be understood that the relative low-pressure conditions have adequate pressure differentials to drive the diaphragm through a full deflection within the actuator housing chamber. More generally, it should be understood that the phrase “discrete positions” is used herein to describe distinct and separate positions, which therefore are not a continuous range of positions.

The third position is a neutral, intermediate position established by a neutral position of the diaphragm 263 and spring 265 when unaffected by any pressure differential between the first and second chamber portions. This intermediate position is not necessarily the center between the first two positions, but rather is selected by analysis and/or experimentation to establish the optimum intermediate position (i.e., the intermediate position resulting in the best overall efficiencies for the operating range over which the intermediate position is used), and established by the geometries of the seam and the spring. In alternative embodiments, other discrete position systems may be used, including pneumatic systems, electromechanical systems, and systems based upon the application of high-pressure air or both high- and low-pressure air.

The application of vacuum to the first or second ports is controlled by an open-loop controller configured to control the actuation of the vanes by the actuator. The controller may be included within the ECU 151, which connects to the turbocharger 101 via the communications connection 153, or may be a separate system. In this context, the term “open-loop controller” should be understood to refer to a controller that does not operate using feedback on the position of the actuator or the resulting flow rate. This feature is distinctive from present-day variable geometry turbochargers, which use active, close-loop control systems to precisely control the actuation of variable geometry members over a continuous range of positions.

The actuator is configured to operate under protocols programmed into the controller, based on a variety of flow conditions. More particularly, the ECU 151 may send control signals to a first solenoid 291 (S1) and a second solenoid 293 (S2) of the actuator, each being configured to expose a respective one of the first and second ports 275 and 277 to either a vacuum source 295 or atmospheric pressure based on the overall flow conditions of which the ECU is informed. More particularly: for the first position, the first solenoid exposes the first port to a vacuum while the second solenoid exposes the second port to atmospheric pressure, for the second position, the first solenoid exposes the first port to atmospheric pressure while the second solenoid exposes the second port to a vacuum, and for the third position, the first and second solenoids expose the first and second ports to atmospheric pressure.

The controller and actuator form an actuation system configured to drive the vanes exclusively between the three discrete positions. In this context, the term “exclusively” should be understood to designate that the actuation system is only configured with protocols for the three positions, and that the actuation system is only configured for actuation specifically to three positions (even though a range of other positions may be passed through in transition between any two of the plurality of discrete positions).

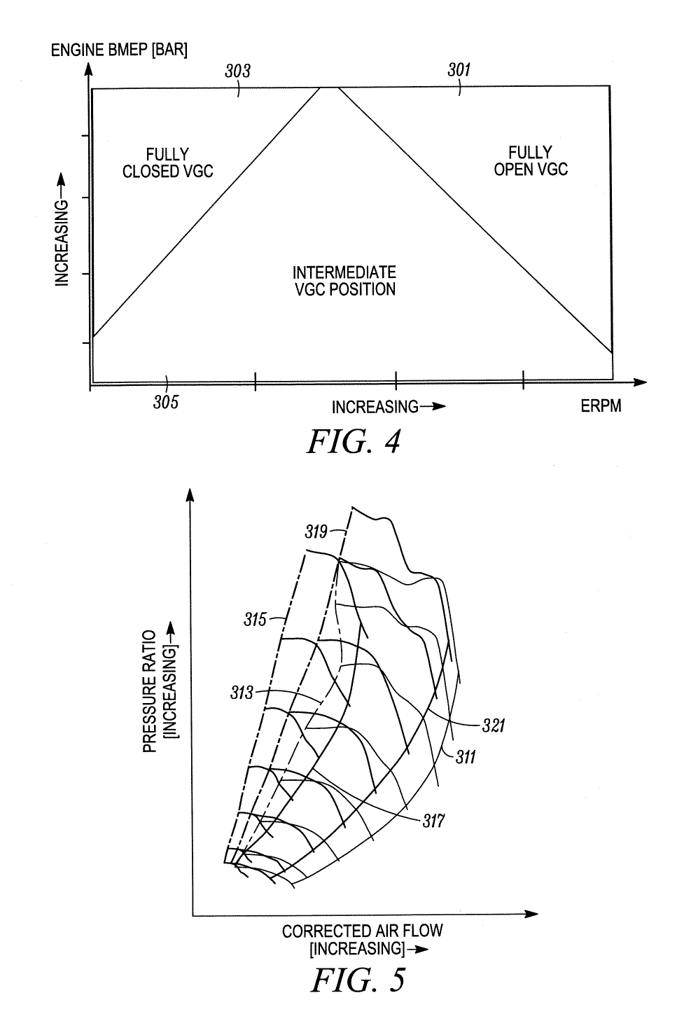

With reference to FIG. 4, which depicts a sample protocol under which the ECU can instruct the actuator to actuate the vanes, it can be seen that the ECU will transmit signals for the vanes to be fully opened (which is a first discrete position) under conditions 301 of high rpm and high brake mean effective pressure (BMEP). Similarly, it can be seen that the ECU will transmit signals for the vanes to be fully closed (which is a second discrete position) under conditions 303 of low rpm and high BMEP. Under other conditions 305, the ECU will typically transmit signals for the vanes to be placed in an intermediate position (which is a third discrete position).

Compressor operation under the compressor's three discrete variable geometry configurations may be better understood with reference to FIGS. 4 and 5. In particular, it may be seen that in the high rpm, high BMEP condition 301, the choke line 311 is positioned well to the right, allowing for high airflow rates. The associated surge line 313 is acceptable for high rpm, high BMEP conditions. In the low rpm, high BMEP condition 303, the surge line 315 allows for substantially higher pressure ratios at a given airflow rate. The associated choke line 317 is acceptable for low rpm, high BMEP conditions. Over most other conditions 305, the surge line 319 and choke line 321 provide for a broad operating range and acceptably high efficiency levels.

While a closed-loop controller and continuous spectrum actuator might provide for slightly higher efficiencies at some operating conditions (i.e., at some positions on the compressor map), typical embodiments of the present invention provide nearly the same level of efficiency at a lower cost, with less weight, and with a higher reliability. Moreover, such embodiments may have better response times and less susceptibility to vanes becoming stuck.

It is to be understood that the invention further comprises related apparatus and methods for designing turbocharger systems and for producing turbocharger systems, as well as the apparatus and methods of the turbocharger systems themselves. In short, the above disclosed features can be combined in a wide variety of configurations within the anticipated scope of the invention.

While particular forms of the invention have been illustrated and described, it will be apparent that various modifications can be made without departing from the spirit and scope of the invention. For example, the actuation system may be configured to operate between a number of descrete positions other than three. Likewise, the actuation system of the invention could be adapted to actuate a variable geometry member of a turbine, such as the turbines disclosed in U.S. Pat. Nos. 6,269,642 and 6,679,057, which are each incorporated herein by reference for all purposes. Moreover, the actuation system could be adapted to actuate variable geometry members of both a turbine and a compressor of a given turbocharger.

Thus, although the invention has been described in detail with reference only to the preferred embodiments, those having ordinary skill in the art will appreciate that various modifications can be made without departing from the scope of the invention. Accordingly, the invention is not intended to be limited by the above discussion, and is defined with reference to the following claims.

What is claimed is:

1. A variable geometry compressor, comprising:
a compressor housing defining an inlet leading to an impeller passageway and an outlet leading from the impeller passageway;
a compressor wheel carried within the compressor housing, the compressor wheel being configured to be driven in rotation within the impeller passageway, and being further configured to compress air received from the inlet and drive that compressed air into the outlet;
a variable geometry member intermediate the compressor wheel and the outlet, the variable geometry member being configured to move through a range of positions that affect the flow of compressed air from the compressor wheel to the outlet; and
an actuation system configured to actuate the variable geometry member exclusively between a plurality of discrete positions from among the range of positions.

2. The variable geometry compressor of claim 1, wherein the actuation system includes an actuator and an open-loop controller that is configured to control the actuation of the variable geometry member by the actuator.

3. The variable geometry compressor of claim 1, wherein the actuation system includes an actuator comprising:
an actuator housing defining an enclosed chamber, a first port opening into the chamber and a second port opening into the chamber;
a diaphragm within the actuator housing, dividing the chamber into a first chamber portion and a second chamber portion, wherein the first port opens into the first chamber portion and the second port opens into the second chamber portion; and
a rod attached to the diaphragm within the chamber and extending out of the chamber, the rod being configured to actuate through a range of positions depending upon deflection of the diaphragm within the chamber.

4. The variable geometry compressor of claim 3, wherein the actuation system further includes an open-loop controller configured to control the actuation of the variable geometry member by the actuator exclusively between three discrete positions, wherein:
the first position is established by the full deflection of the diaphragm when a relative low-pressure condition is established in the first chamber portion;
the second position is established by the full deflection of the diaphragm when a relative low-pressure condition is established in the second chamber portion; and
the third position is established by a neutral position of the diaphragm when unaffected by any pressure differential between the first and second chamber portions.

5. The variable geometry compressor of claim 1, wherein the variable geometry member includes a plurality of vanes positioned in a diffuser intermediate the compressor wheel and the outlet, and wherein the vanes have posts upon which they can rotate, and actuation tabs, and further comprising:
a unison ring having a plurality of slots, the slots receiving the actuation tabs, the unison ring further having an actuation receiver;
wherein actuation of the actuator imparts force to the actuation receiver to urge rotational motion of the unison ring; and
wherein such rotational motion of the unison ring causes the tabs to move in the slots and the vanes to rotate through positions associated with the variable geometry member range of positions.

6. The variable geometry compressor of claim 1, wherein the actuation system is configured to actuate the variable geometry member exclusively between exactly three discrete positions.

7. A turbocharger, comprising the variable geometry compressor of claim 1 and a turbine.

8. A power system, comprising:
an internal combustion engine; and
the turbocharger of claim 7.

9. An actuation system for a variable geometry turbocharger comprising:
an actuator with an actuation member configured to actuate between a plurality of discrete positions; and
an open-loop controller configured to control the actuation of the actuation member between the plurality of discrete positions;
wherein the actuator and controller are configured such that the actuation member is actuated exclusively between the plurality of discrete positions.

10. The actuation system of claim 9, wherein actuator comprises:
an actuator housing defining an enclosed chamber, a first port opening into the chamber and a second port opening into the chamber; and
a diaphragm within the actuator housing, dividing the chamber into a first chamber portion and a second chamber portion, wherein the first port opens into the first chamber portion and the second port opens into the second chamber portion;
wherein the actuation member is a rod attached to the diaphragm within the chamber and extending out of the chamber, the rod being configured to actuate through a range of positions, including the plurality of discrete positions, depending upon deflection of the diaphragm within the chamber.

11. The actuation system of claim 10, wherein the open-loop controller is configured to control the actuation of the rod exclusively between three discrete positions, wherein:
the first position is established by the full deflection of the diaphragm when a relative low-pressure condition is established in the first chamber portion;
the second position is established by the full deflection of the diaphragm when a relative low-pressure condition is established in the second chamber portion; and
the third position is established by a neutral position of the diaphragm when unaffected by any pressure differential between the first and second chamber portions.

12. A turbocharger, comprising:
a compressor configured to be driven by a turbine;
a variable geometry member configured to adjust airflow geometry within the turbocharger; and
the actuation system of claim 9, wherein the actuation system is configured to actuate the variable geometry member exclusively between a plurality of discrete positions.

13. The turbocharger of claim 12, wherein the variable geometry member includes a plurality of vanes positioned intermediate a wheel and a volute, and wherein the vanes have posts upon which they can rotate, and actuation tabs, and further comprising:
a unison ring having a plurality of slots, the slots receiving the actuation tabs, the unison ring further having an actuation receiver;
wherein actuation of the actuator is configured to impart force to the actuation receiver to urge rotational motion of the unison ring; and
wherein such rotational motion of the unison ring causes the tabs to move in the slots and the vanes to rotate through positions associated with the variable geometry member plurality of discrete positions.

14. A power system, comprising:
an internal combustion engine; and
the turbocharger of claim 12.

15. A variable geometry compressor, comprising:
a compressor housing defining an inlet leading to an impeller passageway and an outlet leading from the impeller passageway;
a compressor wheel carried within the compressor housing, the compressor wheel being configured to be driven in rotation within the impeller passageway, and being further configured to compress air received from the inlet and drive that compressed air into the outlet;
a variable geometry member intermediate the compressor wheel and the outlet, the variable geometry member being configured to move through a range of positions that affect the flow of compressed air from the compressor wheel to the outlet; and
a means for actuating the variable geometry member exclusively between a plurality of discrete positions from among the range of positions.

16. A method of actuating a variable geometry compressor that includes a compressor housing defining an inlet leading to an impeller passageway and an outlet leading from the impeller passageway; a compressor wheel carried within the compressor housing, the compressor wheel being configured to be driven in rotation within the impeller passageway, and being further configured to compress air received from the inlet and drive that compressed air into the outlet; and a variable geometry member intermediate the compressor wheel and the outlet, the variable geometry member being configured to move through a range of positions that affect the flow of compressed air from the compressor wheel to the outlet, comprising:
actuating the variable geometry member exclusively between a plurality of discrete positions from among the range of positions.
